(19) United States
(12) Patent Application Publication
(10) Pub. No.: US 2019/0027046 A1
(43) Pub. Date: Jan. 24, 2019

(54) CONNECTED DRIVER COMMUNICATIONS SYSTEM AND PLATFORM

(71) Applicant: AVIS BUDGET CAR RENTAL, LLC, Parsippany, NJ (US)

(72) Inventor: ARTHUR ORDUNA, Kinnelon, NJ (US)

(21) Appl. No.: 15/986,360

(22) Filed: May 22, 2018

Related U.S. Application Data
(60) Provisional application No. 62/509,578, filed on May 22, 2017.

(51) Int. Cl. G08G 1/00; H04W 4/46; G08G 1/0967; G01C 21/36; G06Q 30/02; G07C 5/00

(52) U.S. Cl. CPC G08G 1/22; H04W 4/46; G08G 1/096791; G07C 5/008; G01C 21/3682; G06Q 30/0266; G01C 21/3697

(57) ABSTRACT

A system and platform for establishing continuous, uninterrupted wireless communications with “connected drivers” for the delivery of information and data for a variety of purposes. Connection is through an application running on their smartphone, tablet, or other mobile computing device, or through a networked system or device in the vehicle, including, but not limited to, the vehicle's information/entertainment system or a telematics device or unit. The system provides contextually appropriate and accurate offerings or information to the connected driver globally when operating a vehicle. The offerings or information may be related to a particular location of interest. The system provides offerings or information based on a combination of various factors, including the location of the connected driver or vehicle, the location of various locations of interest, driver profiles with the connected driver system or business partners or participants, driver preference information, information about the particular trip, and predictions of consumer drive-time ecommerce trends and preferences.

This application claims benefit of and priority to U.S. Provisional Application No. 62/509,578, filed May 22, 2018, by Arthur Orduna, and is entitled to the benefit of that filing date. The specifications, drawings, appendices and complete disclosures of U.S. Provisional Applications Nos. 62/509,578, 62/509,617 and 62/509,599, all filed May 22, 2018, are incorporated herein in their entireties by specific reference for all purposes.

### FIELD OF INVENTION

This invention relates to a system and platform for providing contextually-accurate information and offerings to a connected driver during a trip.

### SUMMARY OF INVENTION

In various exemplary embodiments, the present invention comprises a system and platform for establishing continuous, uninterrupted wireless communications with “connected drivers” for the delivery of information and data for a variety of purposes. A “connected driver,” for purposes of this disclosure, is the driver of a vehicle who is continuously and wirelessly connected to remote software platform-based services and applications during the entire duration of their drive time (i.e., “behind the wheel”). Connection is through an application running on their smartphone, tablet, or other mobile computing device, or through a networked system or device in the vehicle, including, but not limited to, the vehicle's information/entertainment system or a telematics device or unit. The connected driver can safely engage the application or networked system or device through voice or touch, or combinations thereof, while driving, and the connection is continuous and uninterrupted (i.e., “always on”) during the journey or trip.

In several embodiments, an application is operated on the driver's smartphone, tablet, or other mobile computing device. The mobile device application also may be used for reserving and accessing a vehicle, and providing services related to the rental of a vehicle or use of a shared vehicle. The mobile device application can be installed on the mobile device or it can be accessed through a web application running on the mobile device. The mobile device is capable of two-way communications with various remote servers that manage information related to the provision of information and services as described herein. The remote servers typically are in direction communication with one or more databases, and may be in connection with each other or with other remote servers (e.g., servers operated by a business partner or participant in the system). The mobile device application receives the information and may display the information or communicate it by sound reproduction, or both. Selections can be made by the driver within the mobile device application by tapping, clicking, or pushing a button, screen, or wheel, or by speaking the selection, depending on the selection options provided by the mobile device or vehicle device.

In further embodiments, the mobile device application has an embedded map system, which may be a map application programming interface (API) that is capable of displaying locations of interest. Using the map system, the driver can search, pan, and zoom to find locations of interest. Members can search for locations that are nearby, in a designated city, or anywhere in the world. Mobile devices with GPS capabilities use the embedded map system to locate and display locations of interest that are near to the mobile device (and thus, the driver and vehicle), or that are within a certain pre-determined distance. Alternatively, the application may use the location of the mobile device based on its cellular-site position. The mobile device application also is capable of providing turn-by-turn directions using the map system (i.e., operating as a navigation system).

Some or all of the functionality provided by the mobile device application may also be provided through a program operating on the vehicle's information/entertainment device or system, on a telematics unit in the vehicle, or combinations thereof. Examples of telematics units and systems are described in U.S. Pat. No. 9,635,518 (issued Apr. 25, 2017 to Avis Budget Car Rental, LLC), which is incorporated herein in its entirety by specific reference for all purposes. The mobile devices, telematics units, and/or vehicle information/entertainment systems may operate as standalone devices, or may be inter-connected by wire/cable or wireless (e.g., by Bluetooth, NFC, or similar communications method).

In several embodiments, the present invention provides contextually appropriate and accurate offerings or information to the connected driver globally when operating a vehicle. The offerings or information may be related to a particular location of interest, but do not need to be limited thereto. In one exemplary embodiment, the connected driver is a user of a rental vehicle or car-sharing service vehicle. However, the connected driver also may be a ride-sharer, a driver of a corporate vehicle, an independent driver, a passenger or rider, a passenger in an autonomous or semi-autonomous vehicle or the like.

The system provides offerings or information based on a combination of various factors, including the location of the connected driver or vehicle, the location of various locations of interest, driver profiles with the connected driver system or business partners or participants, driver preference information (which may be derived from driver profiles, historical or past use information, specific driver-related information, or combinations thereof), information about the particular trip (which may be derived from the driver's mobile device calendar and/or trip applications, such as, but not limited to, Concur or Triplink), and predictions of consumer drive-time ecommerce trends and preferences.

### BRIEF DESCRIPTION OF THE DRAWINGS

FIG. 1 shows a view of a system in accordance with an embodiment of the present invention.

### DETAILED DESCRIPTION OF EXEMPLARY EMBODIMENTS

In various exemplary embodiments, the present invention comprises a system and platform for establishing continuous, uninterrupted wireless communications with “connected drivers” for the delivery of information and data for a variety of purposes. A “connected driver,” for purposes of this disclosure, is the driver of a vehicle who is continuously and wirelessly connected to remote software platform-based services and applications during the entire duration of their drive time (i.e., “behind the wheel”). Connection is through an application running on their smartphone, tablet, or other mobile computing device, or through a networked system or device in the vehicle, including, but not limited to, the vehicle's information/entertainment system or a telematics device or unit. The connected driver can safely engage the application or networked system or device through voice or touch, or combinations thereof, while driving, and the connection is continuous and uninterrupted (i.e., “always on”) during the journey or trip.

In several embodiments, an application is operated on the driver's smartphone, tablet, or other mobile computing device. The mobile device application also may be used for reserving and accessing a vehicle, and providing services related to the rental of a vehicle or use of a shared vehicle. The mobile device application can be installed on the mobile device or it can be accessed through a web application running on the mobile device. The mobile device is capable of two-way communications with various remote servers that manage information related to the provision of information and services as described herein. The remote servers typically are in direction communication with one or more databases, and may be in connection with each other or with other remote servers (e.g., servers operated by a business partner or participant in the system). The mobile device application receives the information and may display the information or communicate it by sound reproduction, or both. Selections can be made by the driver within the mobile device application by tapping, clicking, or pushing a button, screen, or wheel, or by speaking the selection, depending on the selection options provided by the mobile device or vehicle device.

In several embodiments, the mobile device application has an embedded map system, which may be a map application programming interface (API) that is capable of displaying locations of interest. Using the map system, the driver can search, pan, and zoom to find locations of interest. Members can search for locations that are nearby, in a designated city, or anywhere in the world. Mobile devices with GPS capabilities use the embedded map system to locate and display locations of interest that are near to the mobile device (and thus, the driver and vehicle), or that are within a certain pre-determined distance. Alternatively, the application may use the location of the mobile device based on its cellular-site position. The mobile device application also is capable of providing turn-by-turn directions using the map system (i.e., operating as a navigation system).

Some or all of the functionality provided by the mobile device application may also be provided through a program operating on the vehicle's information/entertainment device or system, on a telematics unit in the vehicle, or combinations thereof. Examples of telematics units and systems are described in U.S. Pat. No. 9,635,518 (issued Apr. 25, 2017 to Avis Budget Car Rental, LLC), which is incorporated herein in its entirety by specific reference for all purposes. The mobile devices, telematics units, and/or vehicle information/entertainment systems may operate as standalone devices, or may be inter-connected by wire/cable or wireless (e.g., by Bluetooth, NFC, or similar communications method).

In several embodiments, the present invention provides contextually appropriate and accurate offerings or information to the connected driver globally when operating a vehicle. The offerings or information may be related to a particular location of interest, but do not need to be limited thereto. In one exemplary embodiment, the connected driver is a user of a rental vehicle or car-sharing service vehicle. However, the connected driver also may be a ride-sharer, a driver of a corporate vehicle, an independent driver, a passenger or rider, a passenger in an autonomous or semi-autonomous vehicle, or the like.

The system provides offerings or information based on a combination of various factors, including the location of the connected driver or vehicle, the location of various locations of interest, driver profiles with the connected driver system or business partners or participants, driver preference information (which may be derived from driver profiles, historical or past use information, specific driver-related information, or combinations thereof), information about the particular trip (which may be derived from the driver's mobile device calendar and/or trip applications, such as, but not limited to, Concur or Triplink), and predictions of consumer drive-time ecommerce trends and preferences.

In several exemplary embodiments, all offerings or information provided by the present system to a connected driver in a vehicle are coordinated through one or more servers centrally operated by a provider of the applications described above. These central connected driver system servers are in electronic communication with a plurality of separate servers and networks operated by various business participants or partners (e.g., vendors, merchants, stores, gasoline stations, chambers of commerce, or other providers of goods or services), and offerings or information from these sources are integrated with and provided to the central servers, and thence to selected connected drivers based on the considerations described above. In one embodiment, the vehicles driven by connected drivers are part of a connected fleet, and the central servers are maintained and operated by the owner or operator of the connected fleet (e.g., a car rental or car sharing service). In alternative embodiments, some or all of the business partner or participant servers and networks, or specific stores or facilities at locations of interest, may communicate directly with connected drivers, subject to authorization and oversight from the connected driver system.

Some offerings or services may require payment. In several embodiments, the present invention integrates a digital wallet and payment system, whereby the connected driver can pay for goods or services through the system. Payment can be made through spoken commands, enabling the connected driver to continue safely driving. In several embodiments, pre-payment can be made through the system, thereby minimizing the disruption to the connected driver's travel. Payment is then distributed to the appropriate business partner or participant.

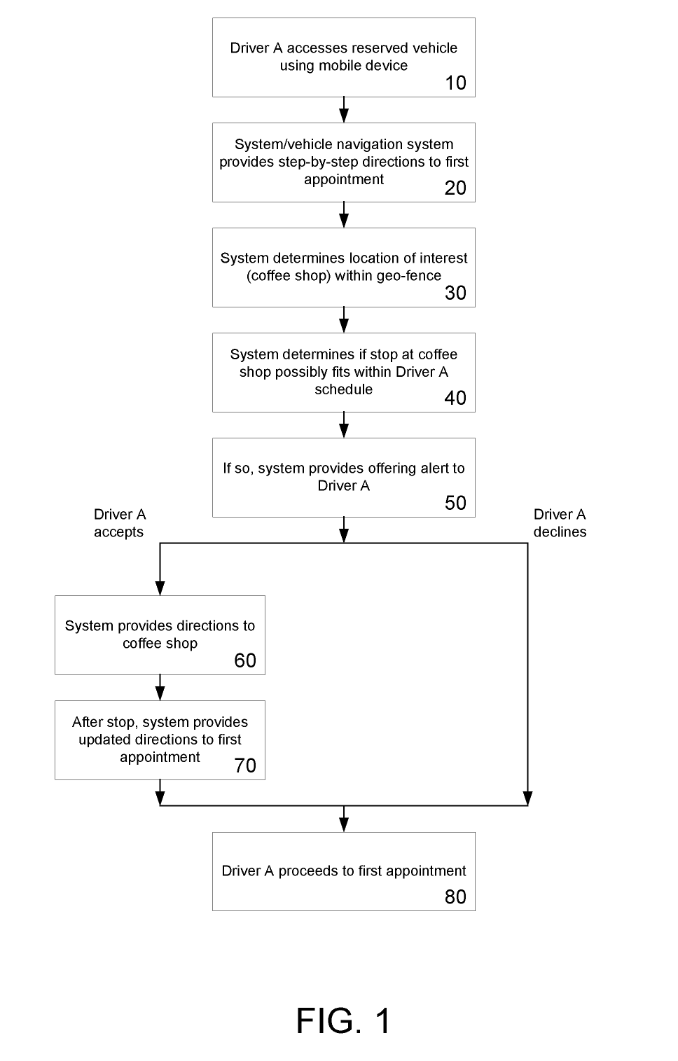

FIG. 1 shows an example of the system of the present invention. Driver A, a connected driver, is a preferred customer of an automobile rental company, which operates a connected driver system in accordance with the present invention. Driver A reserves 10 a vehicle from the automobile rental company for a business trip in a city to which Driver A has never before traveled. The connected driver system has a number of hotels and airlines integrated therewith, so Driver A makes travel arrangements (e.g., air travel and hotel reservations) through the system or using system-integrated businesses. Driver A also has used his or her mobile device's calendar application to schedule several business appoints after arrival. As a result, the system is aware of Driver A's travel plans and schedule timing. Thus, for example, if the flight is delayed, the pick-up time of the rental vehicle may be automatically adjusted.

Driver A also prefers a particular coffee shop chain (e.g., Starbucks), and has an account with Starbuck's online service. Starbucks is a participant or business partner in, and is integrated with, the connected driver system. Thus, the connected driver system has knowledge of Driver A's past purchases and preferences at Starbucks.

On arrival, Driver A accesses the reserved vehicle using his or her mobile device, and begins driving. As it is a new city, Driver A uses a navigation system (on the mobile device or through a device or system in the vehicle) that provides step-by-step directions 20 from the airport to the desired location. As the connected driver system knows the time and location of Driver A's first appointment, the system asks Driver A to confirm that the first destination is the location of the first appointment. Driver A confirms this verbally, or may use the mobile device, navigation system, or other vehicle system or device to respond in the affirmative, such as pressing a “yes” button on a touchscreen. The connected driver system then seamlessly provides (or has already provided) this information to the navigation system.

As Driver A drives from the airport to a first appointment, the connected driver system constantly monitors the location of the vehicle/Driver A, and determines, in real time, if any locations of interest are located within the outer perimeter of a predetermined distance from the vehicle/Driver A (i.e., a “geo-fence”) 30. Multiple geo-fences may be used for different locations of interest based on the services or offerings available. For example, the distance for a geo-fence for a food or drink related location of interest may be shorter or longer than for another form of location of interest. The distance for a particular geo-fence may also change with time and/or location, or based upon a relative importance of the location of interest to Driver A (for example, a distance for a geo-fence for a Starbucks coffee location of interest may be larger if Driver A has a strong preference for Starbuck coffee during a particular window of time in the morning).

It should be noted that while the geo-fence described in this example is a mobile geo-fence based on Driver A's or the vehicle's location, a geo-fence may be determined based on a static location, such as the location of a particular store. The system then determines when Driver A or the vehicle moves into the store's geo-fence area.

In Driver A's case, shortly after leaving the airport, two Starbuck locations are detected within the applicable geo-fence for Starbucks. The system knows that Driver A is likely receptive to an offering from Starbucks because of Driver A's past history of visiting Starbucks while traveling, and Driver A's account with Starbucks. Driver A also may have specifically identified Starbucks as a preferred merchant or vendor or location in Driver A's profile with the system.

Because the system also knows the vehicle location, Driver A's planned destination and route of travel, the current time, current local traffic conditions, and, in some cases, the average wait time at the Starbucks' locations identified, the system determines that one Starbucks location can be reached without causing Driver A to be late for the first appointment 40. The system also may take into account Driver A's recent actions (e.g., if Driver A has already stopped at a Starbucks or another coffee shop recently or within a predetermined window of time from the present, then the system may determine that Driver A's likely interest in another Starbucks visit will be low in that particular context).

The system then provides an offering alert 50 to Driver A, informing Driver A of the presence of the Starbucks that can be reached without delaying the first appointment. The offering alert may be spoken (through the mobile device, navigation system, or other vehicle system or device), or displayed on a visual display ((through the mobile device, navigation system, or other vehicle system or device), or combinations thereof. The offering may include special or discounted offers available at that Starbucks location. The offering also may include asking Driver A if they would like a particular product, which the system can determine based on Driver A's historical purchases at Starbucks in similar circumstances and at similar times.

Driver A responds “yes” verbally to the offering. In alternative embodiments, Driver A may use the mobile device, navigation system, or other vehicle system or device to respond in the affirmative, such as pressing a “yes” button on a touchscreen. The system then automatically updates the navigation system with the Starbucks location, and turn-by-turn directions 60 are then provided to Driver A, who drives to the Starbucks.

If Driver A has confirmed a particular product order prior to arrival, the connected driver system communicates this order to the Starbucks location, directly or indirectly through the Starbucks network. Driver A authorizes payment by digital wallet, and payment is communicated to the Starbucks by the connected driver system. When Driver A nears the Starbucks, an alert is provided to the Starbucks staff through the connected driver system. Upon arrival, Driver A's order is provided (e.g., by a runner bringing the order out to Driver A, by Driver A driving through a pick-up lane or past a pick-up window, or by Driver A parking and entering the store), and Driver A quickly resumes travel. The connected driver system then automatically restores the first appointment location as the destination location for the navigation system, which provides updated turn-by-turn directions 70 from the Starbucks to the first appointment to Driver A, who proceeds to the first appointment 80.

Additional locations of interest may be identified and offerings presented on the trip to the first appointment, or afterwards, as Driver A proceeds to the next appointment, to a hotel, to the airport, or to the next point on Driver A's trip.

In several embodiments, the connected driver system of the present invention thus comprises a mobile ecommerce ecosystem specifically and uniquely addressing the large, global connected driver market based on customer-preference knowledge. The system may be stand-alone and cloud-based. Offerings and information are made available in real-time, and are contextually-accurate based on location (i.e., location-based services, or “LBS”) and on system knowledge about the connected driver and the connected driver's trip or travel plans and recent actions (e.g., does the connected driver prefer a particular type of coffee or food shop, has the connected driver recently stopped at such a location, and the like). Because the system safely targets the right offer to the right driver at the right time at the right place (and seamlessly completes the transaction, if accepted), there is a high degree of certainty that the offers being transmitted will be accepted by the connected driver. This results in a high return-on-investment (ROI) for business participants in the connected driver system, and likely exceeds the return from any other advertisement or product distribution channels.

The provider of the connected driver system can realize revenue from operation of the system in a variety of ways. Business participants, which may include targeted advertising networks, may pay a periodic subscription or membership fee to be a member of the system. In some embodiments, connected drivers may pay a subscription or membership fee as well. The provider may collect a percentage or fee for every transaction completed through the system. The provider also may collect a percentage or fee based on offerings directed to connected drivers (e.g., cost per impression/CPI, or cost per thousand impressions/CPM), or for every “click-through” (e.g., cost per click/CPC) where the connected driver seeks more information about an offering, or visits a particular location of interest (regardless of whether anything is purchased). Business participants (and third parties) may also pay for downloading or accessing digital data for relevant markets in the system.

In several embodiments, the system further comprises an analytic and predictive model for consumer drive-time ecommerce activity and trends. Based on connected driver acceptance and purchase data obtained through the system and business participants, and other data, the system can detect “hot” new products, services and market segments. This information can be provided or sold to business participants or third-parties. In several embodiments, the system provider may work with one or two key new business partners/participants to provide new trending products and services identified by the predictive model.

In order to provide a context for the various computer-implemented aspects of the invention, the following discussion provides a brief, general description of a suitable computing environment in which the various aspects of the present invention may be implemented. A computing system environment is one example of a suitable computing environment, but is not intended to suggest any limitation as to the scope of use or functionality of the invention. A computing environment may contain any one or combination of components discussed below, and may contain additional components, or some of the illustrated components may be absent. Various embodiments of the invention are operational with numerous general purpose or special purpose computing systems, environments or configurations. Examples of computing systems, environments, or configurations that may be suitable for use with various embodiments of the invention include, but are not limited to, personal computers, laptop computers, computer servers, computer notebooks, hand-held devices, microprocessor-based systems, multiprocessor systems, TV set-top boxes and devices, programmable consumer electronics, cell phones, personal digital assistants (PDAs), tablets, smart phones, touch screen devices, smart TV, internet enabled appliances, internet enabled security systems, internet enabled gaming systems, internet enabled watches; internet enabled cars (or transportation), network PCs, minicomputers, mainframe computers, embedded systems, virtual systems, distributed computing environments, streaming environments, volatile environments, and the like.

Embodiments of the invention may be implemented in the form of computer-executable instructions, such as program code or program modules, being executed by a computer, virtual computer, or computing device. Program code or modules may include programs, objects, components, data elements and structures, routines, subroutines, functions and the like. These are used to perform or implement particular tasks or functions. Embodiments of the invention also may be implemented in distributed computing environments. In such environments, tasks are performed by remote processing devices linked via a communications network or other data transmission medium, and data and program code or modules may be located in both local and remote computer storage media including memory storage devices such as, but not limited to, hard drives, solid state drives (SSD), flash drives, USB drives, optical drives, and internet-based storage (e.g., “cloud” storage).

In one embodiment, a computer system comprises multiple client devices in communication with one or more server devices through or over a network, although in some cases no server device is used. In various embodiments, the network may comprise the Internet, an intranet, Wide Area Network (WAN), or Local Area Network (LAN). It should be noted that many of the methods of the present invention are operable within a single computing device.

A client device may be any type of processor-based platform that is connected to a network and that interacts with one or more application programs. The client devices each comprise a computer-readable medium in the form of volatile and/or nonvolatile memory such as read only memory (ROM) and random access memory (RAM) in communication with a processor. The processor executes computer-executable program instructions stored in memory. Examples of such processors include, but are not limited to, microprocessors, ASICs, and the like.

Client devices may further comprise computer-readable media in communication with the processor, said media storing program code, modules and instructions that, when executed by the processor, cause the processor to execute the program and perform the steps described herein. Computer readable media can be any available media that can be accessed by computer or computing device and includes both volatile and nonvolatile media, and removable and non-removable media. Computer-readable media may further comprise computer storage media and communication media. Computer storage media comprises media for storage of information, such as computer readable instructions, data, data structures, or program code or modules. Examples of computer-readable media include, but are not limited to, any electronic, optical, magnetic, or other storage or transmission device, a floppy disk, hard disk drive, CD-ROM, DVD, magnetic disk, memory chip, ROM, RAM, EEPROM, flash memory or other memory technology, an ASIC, a configured processor, CDROM, DVD or other optical disk storage, magnetic cassettes, magnetic tape, magnetic disk storage or other magnetic storage devices, or any other medium from which a computer processor can read instructions or that can store desired information. Communication media comprises media that may transmit or carry instructions to a computer, including, but not limited to, a router, private or public network, wired network, direct wired connection, wireless network, other wireless media (such as acoustic, RF, infrared, or the like) or other transmission device or channel. This may include computer readable instructions, data structures, program modules or other data in a modulated data signal such as a carrier wave or other transport mechanism. Said transmission may be wired, wireless, or both. Combinations of any of the above should also be included within the scope of computer readable media. The instructions may comprise code from any computer-programming language, including, for example, C, C++, C#, Visual Basic, Java, and the like.

Components of a general purpose client or computing device may further include a system bus that connects various system components, including the memory and processor. A system bus may be any of several types of bus structures, including, but not limited to, a memory bus or memory controller, a peripheral bus, and a local bus using any of a variety of bus architectures. Such architectures include, but are not limited to, Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computing and client devices also may include a basic input/output system (BIOS), which contains the basic routines that help to transfer information between elements within a computer, such as during start-up. BIOS typically is stored in ROM. In contrast, RAM typically contains data or program code or modules that are accessible to or presently being operated on by processor, such as, but not limited to, the operating system, application program, and data.

Client devices also may comprise a variety of other internal or external components, such as a monitor or display, a keyboard, a mouse, a trackball, a pointing device, touch pad, microphone, joystick, satellite dish, scanner, a disk drive, a CD-ROM or DVD drive, or other input or output devices. These and other devices are typically connected to the processor through a user input interface coupled to the system bus, but may be connected by other interface and bus structures, such as a parallel port, serial port, game port or a universal serial bus (USB). A monitor or other type of display device is typically connected to the system bus via a video interface. In addition to the monitor, client devices may also include other peripheral output devices such as speakers and printer, which may be connected through an output peripheral interface.

Client devices may operate on any operating system capable of supporting an application of the type disclosed herein. Client devices also may support a browser or browser-enabled application. Examples of client devices include, but are not limited to, personal computers, laptop computers, personal digital assistants, computer notebooks, hand-held devices, cellular phones, mobile phones, smart phones, pagers, digital tablets, Internet appliances, and other processor-based devices. Users may communicate with each other, and with other systems, networks, and devices, over the network through the respective client devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A system for providing information to connected drivers, comprising:
a plurality of vehicles for use by a plurality of drivers;
a plurality of mobile computing devices, at least one mobile computing device from said plurality of mobile computing devices in use by each driver from said plurality of drivers;
one or more central servers in electronic communication with said mobile computing devices, said one or more central servers comprising one or more microprocessors programmed to:
identify when a vehicle from said plurality of vehicles is within a predetermined distance from a location of interest;
determine whether the location of interest has an offering that is contextually appropriate to be electronically communicated to the driver of said vehicle, where contextual appropriateness is based upon two or more of the following factors:
location of the connected driver or vehicle;
location of the location of interest;
driver preference information;
driver actions within a pre-determined period of time prior to the time of determination; and
information about the particular trip; and
communicate a contextually appropriate offering to the driver.

2. The system of claim 1, further comprising at least one geo-fence based upon the connected driver's location.

3. The system of claim 2, wherein the at least one geo-fence comprises an outer perimeter, wherein the distance of the outer perimeter from the connected driver is fixed.

4. The system of claim 2, wherein the at least one geo-fence comprises an outer perimeter, wherein the distance of the outer perimeter from the connected driver is variable.

5. The system of claim 4, wherein the distance is variable based at least in part on the direction of travel of the connected driver.

6. The system of claim 1, wherein the information about the particular trip comprises at least a time for a first appointment, and the system communicates the offering to the driver if the system determines that the connected driver can travel to the location of interest and subsequently proceed to the first appointment without delaying the time for the first appointment.

7. The system of claim 1, wherein the location of interest is a business.

8. The system of claim 1, wherein driver preference information comprises membership in a business customer program.

9. The system of claim 1, wherein driver preference information comprises purchase history at a particular business.

10. The system of claim 1, wherein driver preference information comprises a history of purchases of at least one good or service.

11. The system of claim 1, wherein driver actions comprise a purchase of a good or service within a pre-determined period of time prior to the time of determination.

12. The system of claim 1, wherein said one or more microprocessors are further programmed to:
receive an indication of acceptance of the offering from the driver;
communicate electronically the acceptance of the offering to the location of interest; and
provide directions to the location of interest to the driver.

13. The system of claim 1, wherein the electronic communication of the acceptance includes details for a particular order of at least one good or service from the location of interest.

14. The system of claim 13, wherein the at least one good or service is ready for delivery to the driver at the time the driver arrives as the location of interest.

15. The system of claim 1, wherein contextual appropriateness also is based upon consumer drive-time ecommerce activity and trends according to an analytic and predictive model based in part on acceptance and purchase data from said plurality of drivers.
